(19) United States
(12) Patent Application Publication
(10) Pub. No.: US 2009/0049648 A1
(43) Pub. Date: Feb. 26, 2009

(54) HINGE FOR AN ENCLOSURE

(76) Inventors: Douglas E. Williams, Genoa City, WI (US); Thomas J. Schweiss, Ingleside, IL (US)

Correspondence Address: BRINKS HOFER GILSON & LIONE, P.O. BOX 10395, CHICAGO, IL, 60610, US

(21) Appl. No.: 11/844,628

(22) Filed: Aug. 24, 2007

(51) Int. Cl. E05D 3/00

(52) U.S. Cl. 16/373

(57) ABSTRACT

An enclosure includes a hinge constructed to enable disengagement of a pin receiving member from a pin without substantially damaging the pin receiving member or the pin when the enclosure is opened beyond a fully opened position. The enclosure may include a housing that includes a pin. A pin receiving member may be part of a cover and defines a pin receiving shaft having a lead-in portion. The pin receiving shaft receives and rotatably couples the pin. The lead-in portion is configured to disengage the pin without substantially damaging the pin receiving member when the cover is opened beyond a fully opened position.

### BACKGROUND

1. Technical Field

This application relates to hinges, and more particularly, to hinges for enclosures.

2. Related Art

Hinges may hold separate pieces of an enclosure together so that one piece of the enclosure may move relative to another piece of the enclosure. Some enclosures may limit an amount of rotation through which a hinge may move. This limitation may also limit how far apart from one another the pieces of the enclosure may be separated. In some instances, when the enclosure pieces are separated beyond this limited amount of movement, the hinge and/or the enclosure pieces may be damaged and/or broken.

### SUMMARY

An enclosure includes a hinge constructed to enable disengagement of a pin receiving member from a pin without substantially damaging the pin receiving member or the pin when the enclosure is opened beyond a fully opened position. The enclosure may include a housing that includes a pin. A pin receiving member may be part of a cover and defines a pin receiving shaft having a lead-in portion. The pin receiving shaft receives and rotatably couples the pin. The lead-in portion is configured to disengage the pin without substantially damaging the pin receiving member when the cover is opened beyond a fully opened position.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The application may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of an enclosure with a hinge.

FIG. 2 is a second perspective view of an enclosure with a hinge.

FIG. 3 is a bottom plan view of an enclosure cover.

FIG. 4 is a sectional view along line A-A of the enclosure cover of FIG. 3.

FIG. 5 is a magnified view of a pin receiving member of FIG. 4.

FIG. 6 is a second view of an enclosure with a hinge.

FIG. 7 is a magnified view of the hinge of FIG. 6.

### DETAILED DESCRIPTION OF THE PREFERRED EMBODIMENTS

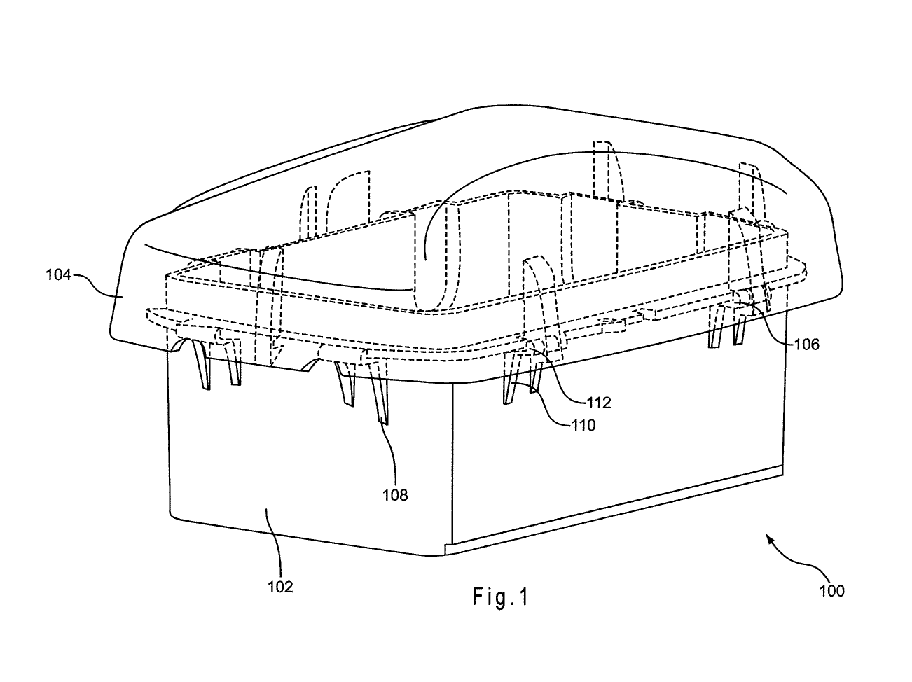

FIG. 1 is a perspective view of an enclosure 100 with a hinge. The enclosure 100 includes a housing 102 and a cover 104. The housing 102 and the cover 104 connect together with one or more hinges 106. The hinges 106 are constructed and arranged so that the housing 102 and the cover 104 separate from one another without substantially damaging the housing 102, the cover 104, and/or the hinges 106 when the cover 104 is opened beyond a normal operating range.

In FIG. 1, the cover 104 of the enclosure 100 is closed and protects any contents inside of the housing 102. The cover 104 may include an inside surface and an outside surface. Some covers 104 may include a curvature in a longitudinal and/or latitudinal direction. Alternatively, a cover 104 may not have a curvature. The cover 104 may be formed with sides that may surround a portion of the housing 102 when the cover 104 is in a closed position. A shape of the housing 102 may depend upon an application. In some applications, the housing 102 may have a generally rectangular or generally square shape. In other applications, the housing 102 may be generally obround, hexagonal, octagonal, or other shapes.

One or more pairs of ribs 108 may be provided along one or more sides of the housing 102. The ribs 108 may be formed with the housing 102 or may be attached to the housing 102 with a fastener, clamp, or other coupling. A rib 108 may include an angled portion 110 that protects away from the housing 102 and an arm portion 112. The angled portion 110 may act as a stop when the cover 102 is opened. In some implementations, the cover 102 will be in a fully opened position when an edge of the cover 104 rests against the angle portion 110 of the rib 108. The arm portion 112 may extend out from the housing 102 at the top of the angled portion 110 of the rib 108. The angle portion 110 and the arm portion 112 of the rib 108 may be a continuous piece of material, or may be separate pieces joined together. In some implementations, the angle portion 110 and the arm portion 112 of the rib 108 may be formed with the housing 102.

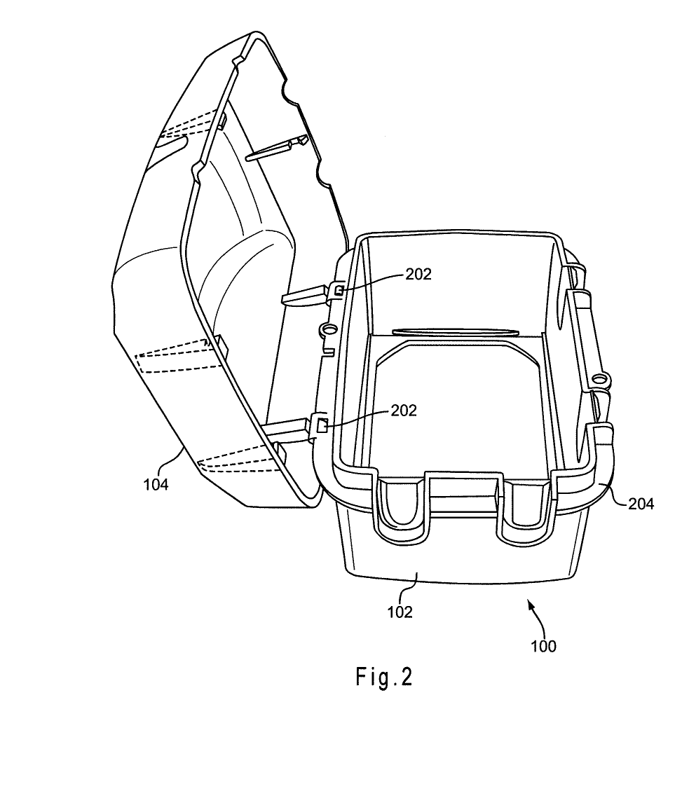

FIG. 2 is a second perspective view of an enclosure 100 with a hinge 106. In FIG. 2, the cover 104 of the enclosure 100 is open. As shown in FIG. 2, a pin 202 may extend between the arms 112 of a pair of ribs 108. The pin 202 may be offset from the housing 102 to create a gap between the pin 202 and the housing 102. Alternatively, the pin 202 may be formed with a housing that does not include ribs.

When the cover 104 of the enclosure 100 is open, a user may access the inside of the housing 102. In FIG. 2, the housing 102 may include a lip 204. The lip 204 may be positioned a predetermined distance from the top of the housing 102. The lip 204 may perpendicularly extend away from the housing 102, and may have an outer edge shape that generally matches the inside shape of the cover 104. In some enclosures 100, when the cover 104 is in a closed position, the lip 204 may extend to substantially meet the inside surface of the cover 104. Alternatively, the lip 204 may be formed to create a gap between an edge of the lip 204 and an inside surface of the cover 104. The lip 204 may substantially protect the inside of the housing from weather elements when the cover 104 is in a closed position.

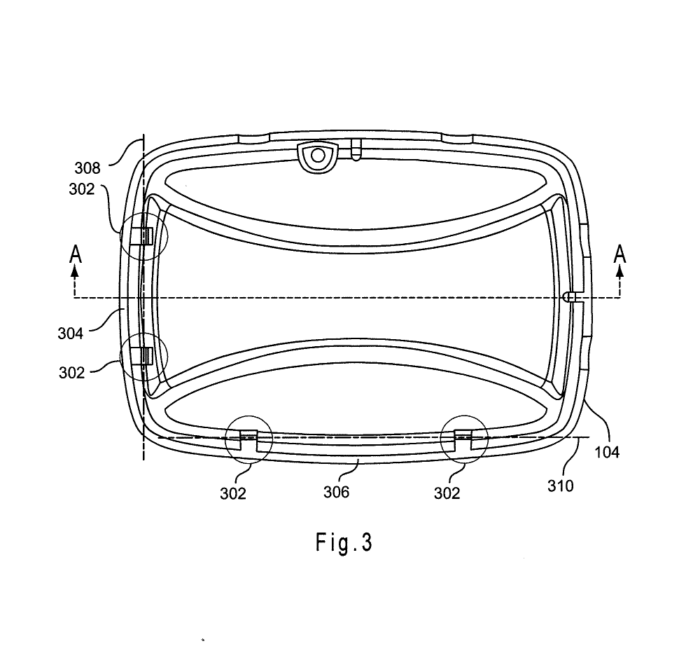

FIG. 3 is a bottom plan view of an enclosure cover 104. One or more pin receiving members 302 may be attached to or formed with the enclosure cover 104. In FIG. 3, there are four pin receiving members 302. Two pin receiving members 302 are located on an inside surface of a first side 304 of the cover 104, and two pin receiving members 302 are located on an inside surface of a second side 306 of the cover 104. The placement of the pin receiving members 302 may correspond with the location of pins 202. Placement of the pins 202 and pin receiving members 302 on more than one side of the housing 102 enables the enclosure 100 to have different opening configurations. As shown in FIG. 3, the pin receiving members 302 on the first side 304 of the cover 104 may receive corresponding pins so that the cover 104 may be opened by rotating it about a first axis 308. Alternatively, the pin receiving member 302 on the second side 306 of the cover 104 may receive corresponding pins so that the cover 104 may be opened by rotating it about a second axis 310. Depending on the orientation of the enclosure, either of the first axis 308 or the second axis 310 may be oriented in a horizontal or vertical direction.

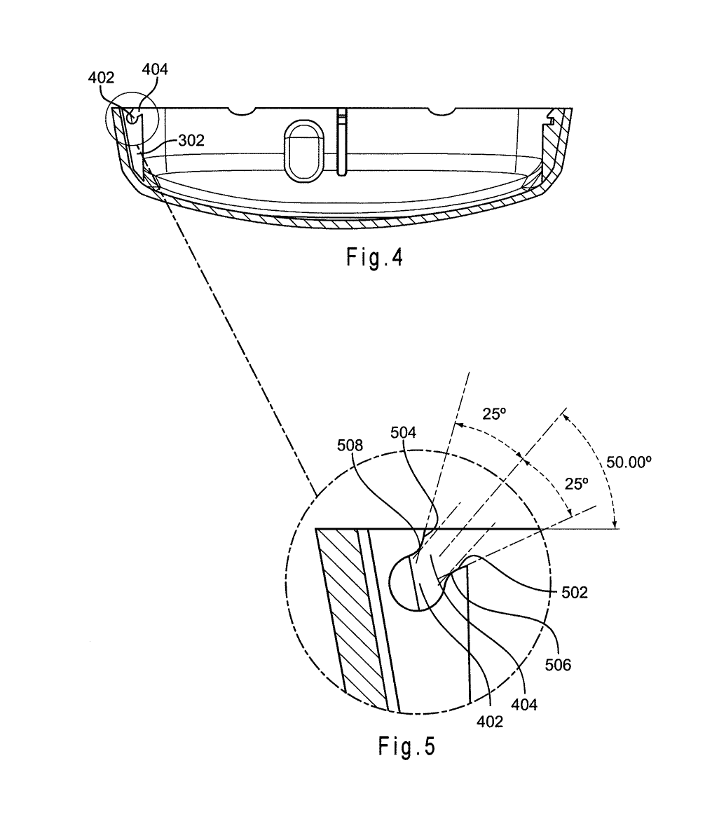

FIG. 4 is a sectional view of the cover of FIG. 3 taken along line A-A. A pin receiving member 302 is formed with the cover 104, and extends away from an inside surface of the cover 104 towards an inner area underneath the cover 104. The pin receiving member 302 is formed to define a pin receiving shaft 402 and a lead-in portion 404.

FIG. 5 is a magnified view of the pin receiving member 302 of FIG. 4. The lead-in portion 404 of the pin receiving member 302 may include a first side 502 and a second side 504. The first side 502 and the second side 504 may be substantially symmetrical about an imaginary line that extends through about the center of the lead-in portion 404 and passes through about a center of the pin receiving shaft 402. The first side 502 and the second side 504 may be angled or tapered with respect to the center of the pin receiving shaft 402. The angle between the first side 502 and the second side 504 may be between about 10° and about 90°. In some implementations, the angle may be about 50°.

Each of the first side 502 and the second side 504 of the lead-in portion 404 may transition into the pin receiving shaft 402 at first and second transition points 506 and 508, respectively. A first lead-in angle may be an angle between the first side 502 and an imaginary line extended tangentially to the transition point 506, and may be between about 5° and about 45°. In some implementations, the first lead-in angle may be about 25°. A second lead-in angle may be an angle between the second side 504 and an imaginary line extended tangentially to the transition point 508, and may be between about 5° and about 45°. In some implementations, the second lead-in angle may be about 25°. In some implementations, the angle between the first side 502 and the second side 504 may about twice the size of the first or second lead-in angle.

In FIG. 5, a gap or distance between the first transition point 506 and the second transition point 508 may be less than a distance across and passing through a center of the pin receiving shaft 402. The pin receiving member 302 may be formed from a material that will allow the gap between the first transition point 506 and the second transition point 508 to expand when a predetermined force is exert on a pin 202 pressed against the transition points 506, 508. This expansion will enable the pin 202 to be inserted into the pin receiving shaft 402. After passing through the transition point gap, the transition points may return to their original position thereby retaining the pin 202 in the pin receiving shaft 402.

The pin receiving shaft 402 may rotatably couple the pin 202. In some implementations, the pin receiving shaft 402 may rotate around the pin 202 between about 90° and about 170° to a fully opened position. Alternatively, the enclosure 100 may be configured so that the cover 104 is in a fully opened position when the pin receiving shaft 402 has rotated around the pin 202 less than about 90° or more than about 170°. When the cover 104 is opened beyond a fully opened position, an edge of the cover 104 may exert a force on a rib 108 or a portion of the housing 102. This force disengages the pin receiving shaft 402 from the pin 202 without substantially damaging the pin receiving shaft 402, the pin 202, the housing 102, and/or the pin receiving member 302.

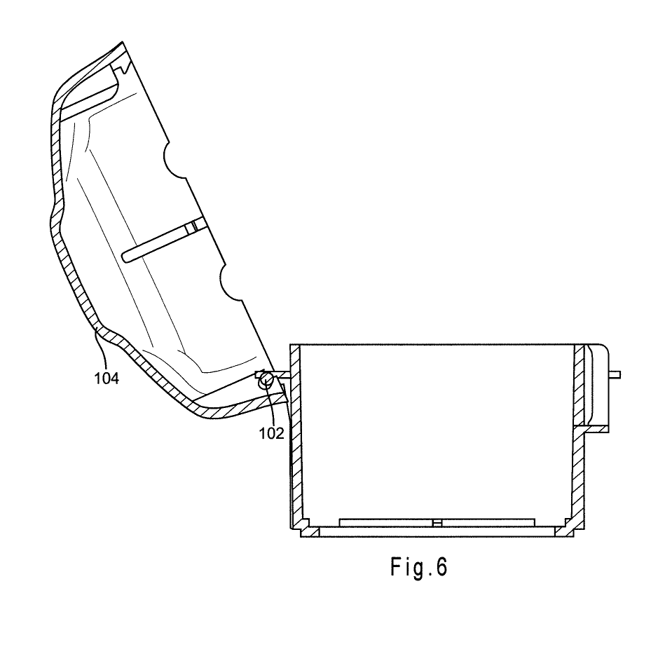

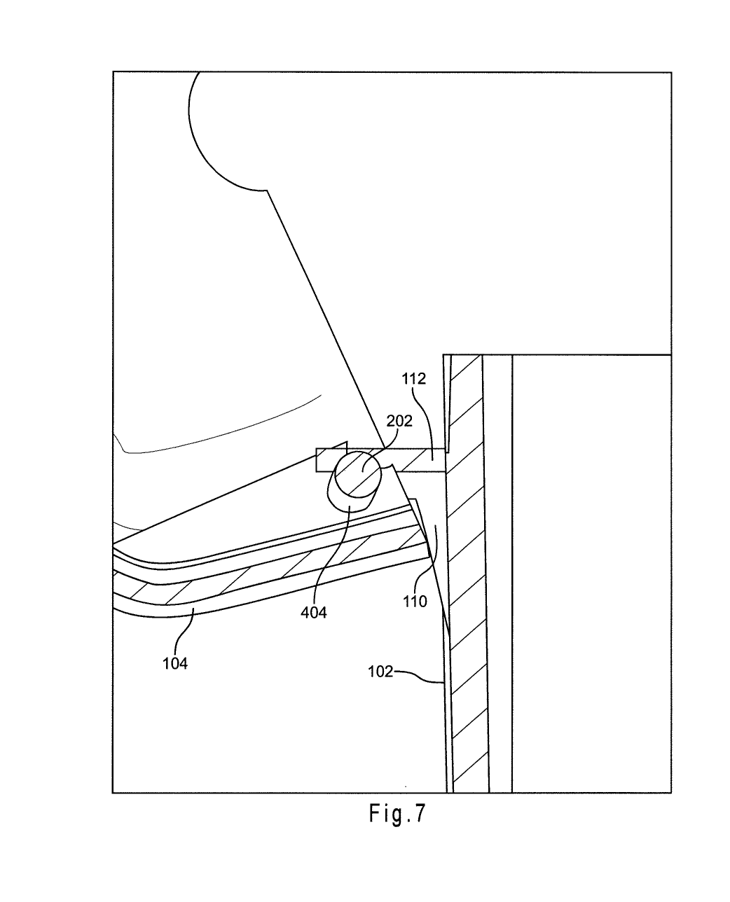

FIG. 6 is a second view of an enclosure 100 with a hinge 106. In FIG. 6, the cover 104 is opened beyond a fully opened position, and the pin receiving shaft 402 is disengaging from the pin 202. FIG. 7 is a magnified view of the hinge section of FIG. 6. In FIG. 7, the force exerted by the edge of the cover 104 against the rib 108 begins to force the pin 202 out of pin receiving shaft 402. As the cover 104 is opened further, the force increases and the pin 202 is forced out of the pin receiving shaft 402. As the pin 202 is forced out of the pin receiving shaft 402, the gap between the first transition point and the second transition point again expands allowing the pin 202 to enter the lead-in portion 404 at which point the cover 104 may be separated from the housing 102 without substantially damaging the enclosure 100 or its hinge 106.

The housing 102, cover 104, pin 202, and/or pin receiving member 302 may be formed from a weather-resistant, rigid, electrically non-conductive material. In some implementations, this electrically non-conductive material includes polycarbonate, polystyrene, polyvinylchloride, or other plastic materials. In some implementations, the housing 102 is formed from polycarbonate. In some implementations, the cover 104 is made of a translucent material to allow for observation of the interior of the enclosure 100 when the cover 104 is in a closed position. In other implementations, the cover 104 is made of an opaque material.

The enclosure 100 may be an outdoor weather-resistant electrical outlet box. The electrical outlet box may be mounted on the exterior of a building, tree, post, or other structure to provide power to an outdoor area. Alternatively, the enclosure 100 may be formed to be recessed into a structure. In yet other implementations, the pin receiving member and the pin described above may be used in indoor enclosures and/or in connection with enclosures that are not electrical outlet boxes, such as storage containers.

Although FIGS. 1-7 show the pin being part of the housing and the pin receiving member being part of the enclosure cover, other configurations may be employed. In some configurations, the pin may be part of the enclosure member and the pin receiving member may be part of the housing. In yet other configurations, some pins may be part of the housing and some pins may be part of the enclosure cover. In these configurations, corresponding pin receiving members may be part of the enclosure cover and the housing.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. An enclosure with a hinge, comprising:
a housing that includes a pin; and
a cover that includes a pin receiving member that defines a pin receiving shaft having an angled lead-in portion,
where the pin receiving shaft rotatably couples the pin, and the where the angled lead-in portion is configured to disengage the pin without substantially damaging the pin receiving member when the cover is opened beyond a fully opened position.

2. The enclosure of claim 1, where an angle between a first inside surface of the angled lead-in portion to a second inside surface of the angled lead-in portion is between about 10° and about 90°.

3. The enclosure of claim 1, where an inside surface of the pin receiving shaft transitions into the angled lead-in portion at a transition point.

4. The enclosure of claim 3, where an angle between a first inside surface of the angled lead-in portion and an imaginary line extended tangential to the transition portion is between about 5° and about 45°.

5. The enclosure of claim 3, further comprising an opening angle and a lead-in angle, where the opening angle comprises an angle between a first inside surface of the angled lead-in portion and a second inside surface of the angled lead-in portion, and where the lead-in angle comprises an angle between a first inside surface of the angle lead-in portion and an imaginary line extended tangential to the transition portion, and where the opening angle comprises about twice the lead-in angle.

6. The enclosure of claim 1, where the pin receiving member is configured to allow the cover to rotate through a rotation angle before the cover reaches its fully opened position, and where the rotation angle ranges between about 90° and about 170°.

7. The enclosure of claim 1, where an edge of the cover is configured to exert a force on the housing when the cover is opened beyond a fully opened position.

8. The enclosure of claim 7, where the force disengages the pin receiving shaft from the pin.

9. A pin receiving member of a hinge, comprising
a lead-in portion having an opening that tapers and transitions into a pin receiving shaft, where the lead-in portion taper is substantially symmetrical about an imaginary line passing through the lead-in portion opening and a center of the pin receiving shaft.

10. The pin receiving member of claim 9, where an angle between a first tapered side of the lead-in portion and a second tapered side of the lead-in portion comprises about 50°.

11. The pin receiving member of claim 9, where the tapered end of the lead-in portion comprises a gap that is smaller than the opening of the lead-in portion and smaller than a distance across and through a center of the pin receiving shaft.

12. An enclosure with a hinge, comprising:
a cover that includes a pin; and
a housing that includes a pin receiving member that defines a pin receiving shaft having an angled lead-in portion,
where the pin receiving shaft rotatably couples the pin, and the where the angled lead-in portion is configured to disengage the pin without substantially damaging the pin receiving member when the cover is opened beyond a fully opened position.

13. The enclosure of claim 12, where an opening of the pin receiving shaft is smaller than a diameter of the pin.

14. The enclosure of claim 12, where an angle between a first inside surface of the angled lead-in portion to a second inside surface of the angled lead-in portion is between about 10° and about 90°.

15. The enclosure of claim 12, where an inside surface of the pin receiving shaft transitions into the angled lead-in portion at a transition point.

16. The enclosure of claim 15, where an angle between a first inside surface of the angled lead-in portion and an imaginary line extended tangential to the transition portion is between about 5° and about 45°.

17. The enclosure of claim 15, further comprising an opening angle and a lead-in angle, where the opening angle comprises an angle between a first inside surface of the angled lead-in portion and a second inside surface of the angled lead-in portion, and where the lead-in angle comprises an angle between a first inside surface of the angle lead-in portion and an imaginary line extended tangential to the transition portion, and where the opening angle comprises about twice the lead-in angle.

18. The enclosure of claim 12, where the pin receiving member is configured to allow the cover to rotate through a rotation angle before the cover reaches its fully opened position, and where the rotation angle ranges between about 90° and about 170°.

19. The enclosure of claim 12, where an edge of the cover is configured to exert a force on the housing when the cover is opened beyond a fully opened position.

20. The enclosure of claim 19, where the force disengages the pin receiving shaft from the pin.

21. A hinge for an enclosure assembly, comprising:
a pin; and
means for detachably coupling a pin receiving member formed within a first enclosure piece to the pin, where the pin receiving member disengages the pin without substantially damaging the pin receiving member when the first enclosure piece is opened beyond a fully opened position.

22. The hinge for the enclosure assembly of claim 21, where the first enclosure piece comprises an electrical outlet box cover.

23. The hinge for the enclosure assembly of claim 22, where the pin is part of an electrical outlet box housing.

24. The hinge for the enclosure assembly of claim 21, where the first enclosure piece comprises an electrical outlet box housing.

25. The hinge for the enclosure assembly of claim 24, where the pin is part of an electrical outlet box cover.
